(19) United States
(12) Patent Application Publication
(10) Pub. No.: US 2012/0256562 A1
(43) Pub. Date: Oct. 11, 2012

(54) DISPLAY APPARATUS

(75) Inventors: Satoru Shiobara, Mobara-shi (JP); Takayuki Sumida, Kawasaki-shi (JP)

(73) Assignee: CANON KABUSHIKI KAISHA, Tokyo (JP)

(21) Appl. No.: 13/439,618

(22) Filed: Apr. 4, 2012

(30) Foreign Application Priority Data
Apr. 7, 2011 (JP) 2011-085397

(51) Int. Cl. H05B 33/12

(52) U.S. Cl. 315/312

(57) ABSTRACT

Each pixel in a display apparatus includes a plurality of sub-pixels configured to emit light with different luminescent colors. Each of the sub-pixels includes an organic EL element. A high-refractive-index transparent layer having a refractive index higher than that of an organic compound layer in the organic EL element is provided on a light emitting side of the organic EL element. A light extraction structure is provided on a light emitting side of the high-refractive-index transparent layer. The light extraction structure is provided on the sub-pixels, and is not in an interpixel region.

### BACKGROUND OF THE INVENTION

1. Field of the Invention

The present invention relates to a display apparatus including organic electroluminescence (EL) elements, and more particularly, to a full-color display apparatus in which each one pixel includes a plurality of sub-pixels for emitting light with different colors.

2. Description of the Related Art

In recent years, organic light emitting elements that perform self luminescence at a low driving voltage of about several volts have attracted attention. By virtue of outstanding features, such as surface-emitting property, light weight, and high visibility, an organic EL element is proceeding toward practical utilization as a light emitting element for use in a flat panel display, a lighting apparatus, a head mount display, or a print head light source of an electrophotographic printer.

An organic EL element has a structure in which a light emitting layer formed of an organic material and a plurality of other functionally separated layers formed of organic materials are sandwiched between an anode and a cathode. At least an electrode on a light emitting side is transparent. Because of this layered structure, when light travels in a direction at an angle more than a critical angle of interfaces determined by the refractive index of the light emitting layer, the medium of the light emitting side, and the refractive index of air in which the light is finally emitted, the light is totally reflected and is confined as propagation light in the element. The propagation light is absorbed by an organic compound layer and a metal electrode in the element, and is not extracted outside. This reduces the light extraction efficiency.

To extract propagation light outside for enhancement of the light extraction efficiency, various methods have been proposed, which change the light traveling direction by forming a fine uneven structure or a lens structure on a light emitting surface so as to disturb a total reflection condition. Japanese Patent Laid-Open No. 2004-296429 proposes a method that is particularly effective in enhancing the light extraction efficiency. In this method, a transparent layer having a refractive index higher than or equal to that of a light emitting layer is provided in contact with a light emitting side of a transparent electrode, and a region for disturbing light reflection and scattering angles is provided on a light emitting side of or in the transparent layer.

In this method, according to the traditional Snell's law, propagation light in the light emitting layer, which makes up about 80% of light emitted from the light emitting layer, is brought into the high-refractive-index transparent layer having a refractive index higher than that of the light emitting layer, where the propagation light is converted into propagation light in the transparent layer. The propagation light can be extracted outside by the region provided on the surface of or in the transparent layer to disturb the light reflection and scattering angles.

However, this method for propagating light in the high-refractive-index transparent layer has problems unique to application to a display apparatus such as a display. When light is led into the high-refractive-index transparent layer and is finally extracted into air by the region for disturbing the light reflection and scattering angles, the light includes light traveling at an angle larger than or equal to the critical angle. This traveling light is normally subjected to total reflection. Therefore, it is recognized, because of parallax resulting from the thickness of the high-refractive-index transparent layer, that the light is emitted from a position different from an actual light emitting point. This causes a problem of bleeding of a display image. To address this problem, Japanese Patent Laid-Open No. 2005-322490 proposes a method in which the thickness of a substrate in which light propagates, not a high-refractive-index transparent layer, is limited to be lower than or equal to a given ratio of the pixel size.

Further, when the light led into the high-refractive-index transparent layer enters the disturbing region that disturbs the light reflection and scattering angles, it is not always extracted into air at one time. Even when the traveling direction is changed by the disturbing region, the light traveling at the angle larger than or equal to the critical angle of the interface between the high-refractive-index transparent layer and air is totally reflected again, and propagates in the high-refractive-index transparent layer. As a result, the light laterally propagates in the high-refractive-index transparent layer, and is eventually emitted into air from a position distant from the light emitting point where the total reflection condition is disturbed. Hence, a problem of bleeding of a display image also occurs. In particular, since the amount of light of a high-angle component increases as the refractive index of the transparent layer increases, the number of entries in the disturbing region is reduced, and the distance by which the light is laterally guided until it is extracted into air is increased.

### SUMMARY OF THE INVENTION

The present invention reduces bleeding of a display image by efficiently extracting, to the outside, propagation light that propagates in a transparent layer having a refractive index higher than that of an organic compound layer in a display apparatus using an organic EL element.

A display apparatus according to an aspect of the present invention includes a plurality of pixels each including a plurality of sub-pixels configured to emit light with different colors. Each of the sub-pixels has an organic EL element including a first electrode, a second electrode, and an organic compound layer including a light emitting layer provided between the first electrode and the second electrode. A transparent layer having a refractive index higher than a refractive index of the organic compound layer is provided on a light emitting side of the organic EL element. A light extraction structure is provided on a light emitting side of the transparent layer. The light extraction structure is provided on the sub-pixels in the pixels and is not provided on a region between two adjacent pixels.

According to the present invention, it is possible to provide a display apparatus that reduces bleeding of a display image while enhancing light extraction efficiency.

Further features of the present invention will become apparent from the following description of exemplary embodiments with reference to the attached drawings.

### BRIEF DESCRIPTION OF THE DRAWINGS

FIG. 1 illustrates a planar layout of sub-pixels in an example of a display apparatus of the related art.

FIG. 2 schematically illustrates a planar layout of a display apparatus according to an embodiment of the present invention.

FIG. 3 is a schematic cross-sectional view of a display apparatus of the embodiment.

FIG. 4 is a schematic cross-sectional view of a sub-pixel in the display apparatus.

FIG. 5 illustrates another planar layout of light extraction structures in the display apparatus.

FIGS. 6A to 6C illustrate further planar layouts of light extraction structures in the display apparatus.

FIGS. 7A and 7B are plan views illustrating the relationship between the size of bottom faces of the light extraction structures and the center-to-center distance of the light extraction structures in the display apparatus.

FIG. 8 schematically illustrates a planar layout of a display apparatus according to another embodiment of the present invention.

### DESCRIPTION OF THE EMBODIMENTS

An organic EL element includes, on a first electrode, several organic compound layers including a light emitting layer having a light emission region, and a second electrode. The organic EL element emits light by utilizing energy produced when a hole and an electron injected in the organic compound layers are recombined by applying voltage between the first electrode and the second electrode. One of the first electrode and the second electrode is a reflection electrode, and the other is a transparent electrode. One of the first electrode and the second electrode is an anode, and the other is a cathode. In the display apparatus of the present invention, the reflection electrode is provided as the first electrode on a support substrate, and light is extracted from the transparent electrode. In the display apparatus of the present invention, a high-refractive-index transparent layer having a refractive index higher than that of the organic compound layers is provided adjacent to the transparent electrode so as to effectively extract the light emitted in the organic EL element to the outside. Further, a light extraction structure is provided adjacent to the high-refractive-index transparent layer so as to extract the light. With this structure, light from the light emitting layer reaches the light extraction structure without being totally reflected, and is effectively extracted outside.

In the present invention, a region where the light extraction structure is provided and a region where the light extraction structure is not provided are separately provided to suppress bleeding of a display image. This suppresses bleeding of a display image resulting from color mixture in an interpixel region.

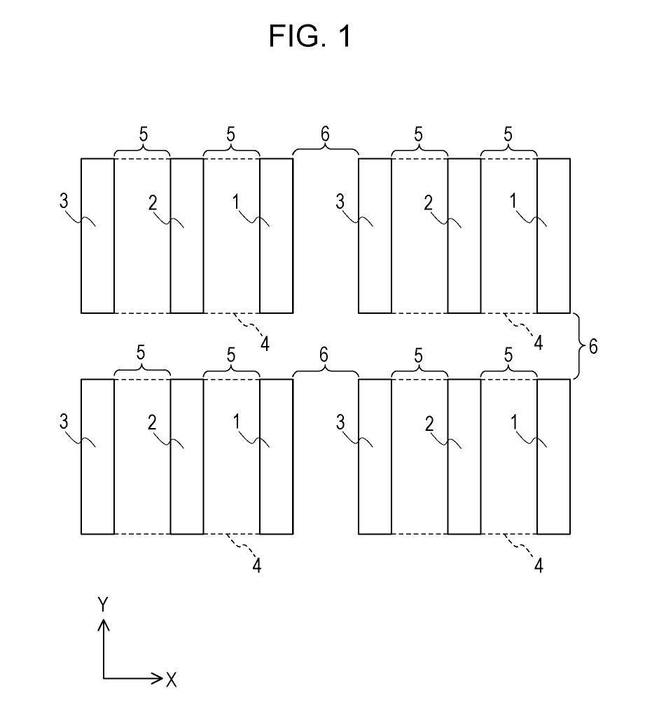

An embodiment of the present invention will be described below. FIG. 1 illustrates a planar layout of an example of a display apparatus of the related art. Sub-pixels 1, 2, and 3 that emit light with three primary colors of blue, green, and red constitute one pixel 4. Here, a pixel 4 includes at least three sub-pixels 1, 2, and 3 and two inter-sub-pixel regions 5. In contrast, interpixel regions 6 refer to regions provided between two adjacent pixels 4, and more specifically, to regions between sub-pixels 1 and 3 included in the adjacent pixels.

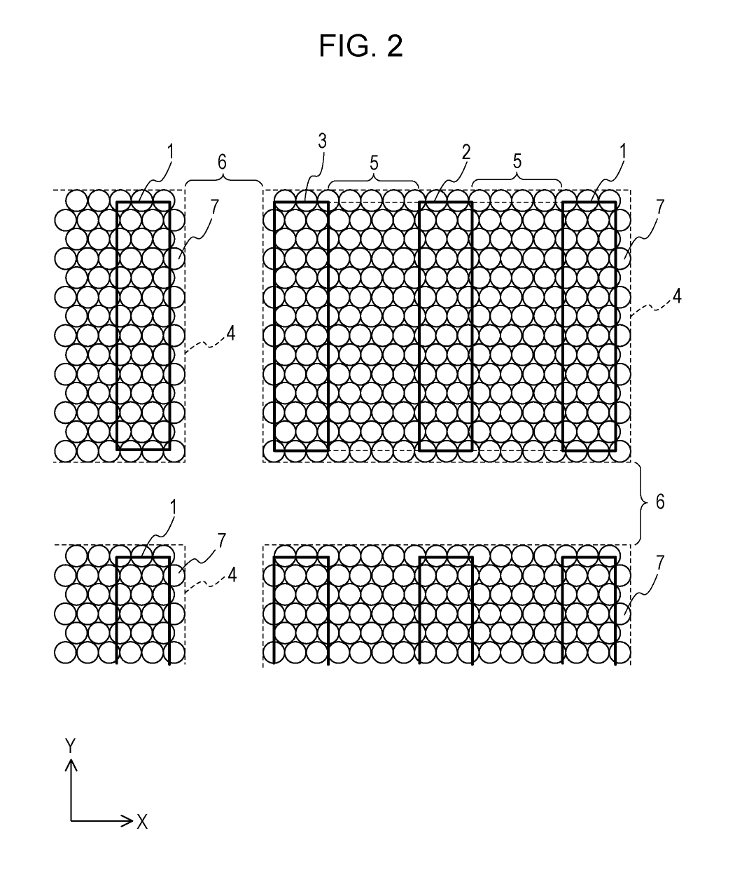

FIG. 2 illustrates a planar layout of a display apparatus according to an embodiment of the present invention, in which light extraction structures 7 are added to the structure of the display apparatus of the related art illustrated in FIG. 1. In the display apparatus of the embodiment, as illustrated in FIG. 2, light extraction structures 7 are provided on pixels 4, and the light extraction structures 7 are not provided on interpixel regions 6. In the display apparatus of the embodiment, each pixel 4 includes a plurality of sub-pixels 1, 2, 3 and the light extraction structures 7, and forms the smallest unit of display. When an area where the light extraction structures 7 are provided is larger than an area where the sub-pixels 1, 2, and 3 are provided, the entire area including the light extraction structures 7 is defined as a pixel 4. While it is satisfactory as long as the light extraction structures 7 are provided on the sub-pixels 1, 2, and 3, they may be provided over the sub-pixels 1, 2, and 3 and regions adjacent to the sub-pixels.

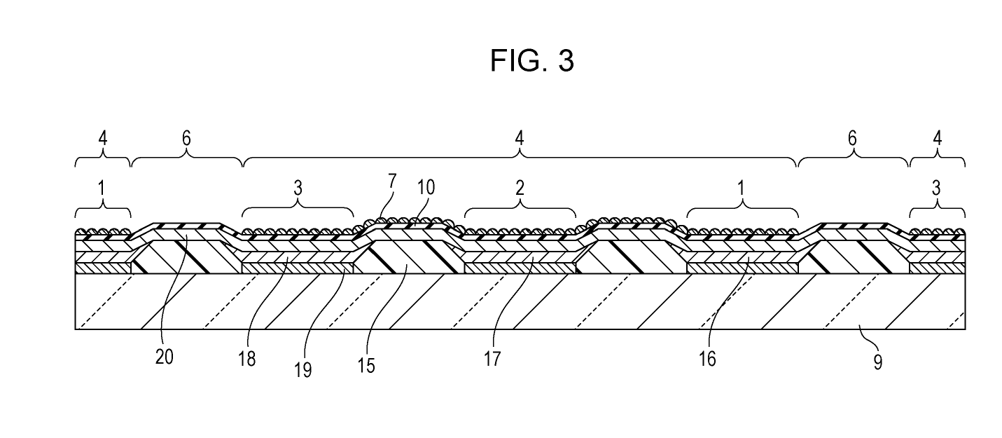

In the display apparatus of the embodiment, light emission regions of the sub-pixels 1, 2, and 3 are determined by the area of an electrode patterned on a below-described support substrate. In this case, the display apparatus has a cross-sectional structure schematically illustrated in FIG. 3.

In the structure of FIG. 3, partitions 15 are provided to avoid crosstalk and a short circuit between the pixels and a break of an electrode wire, or to isolate the electrodes to limit light emission regions. However, the partitions 15 may be omitted. In FIG. 3, openings defined by the partitions 15 in sub-pixels correspond to the sub-pixels 1, 2, and 3 in FIG. 1.

The sub-pixels 1, 2, and 3 are formed by organic EL elements that emit light having different luminescent colors. In FIG. 3, the sub-pixels 1, 2, and 3 each include a reflection electrode 19 provided as first electrode on a support substrate 9, an organic compound layer 16, 17, or 18 provided on the reflection electrode 19, and a transparent electrode 20 provided as a second electrode on a light emitting side. The organic compound layers 16, 17, and 18 each include a light emitting layer that emits light in correspondence with the luminescent color of the corresponding sub-pixel 1, 2, or 3. The transparent electrode 20 is continuously provided over the entire display region, and has, on a light emitting side (a side opposite the support substrate 9), a high-refractive-index transparent layer 10 having a refractive index higher than that of the organic compound layers 16, 17, and 18. Further, light extraction structures 7 are provided on a light emitting side of the high-refractive-index transparent layer 10.

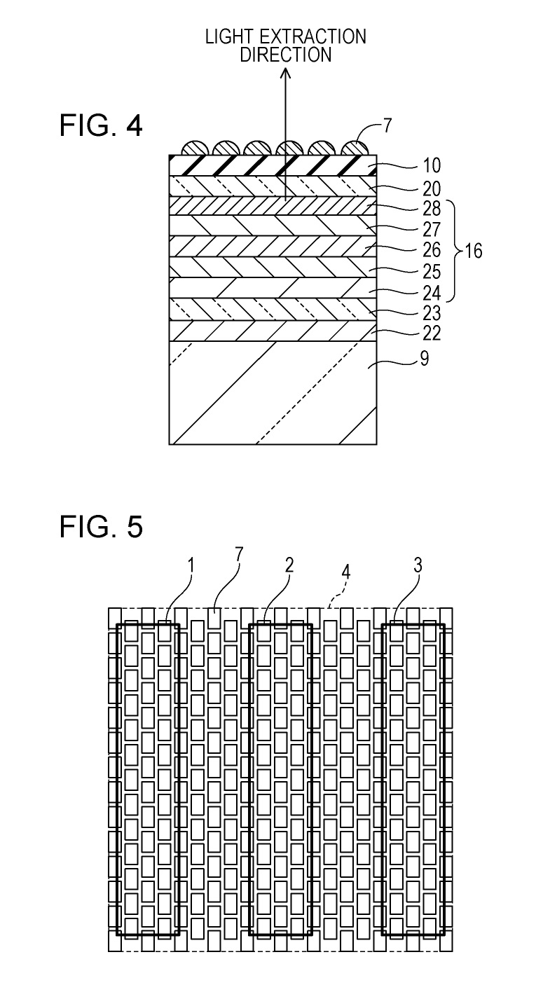

FIG. 4 illustrates an exemplary cross-sectional structure of the organic EL element used in each sub-pixel 1. Cross-sectional structures of the organic EL elements used in the sub-pixels 2 and 3 are similar to the structure of FIG. 4. Several organic compound layers 16 including a light emitting layer are provided between a reflection electrode 22 and a transparent electrode 23 provided as a first electrode on the support substrate 9, and a transparent electrode 20 provided as a second electrode. It is well known that there are various layer structures from viewpoints of light emission efficiency, driving life, and optical interference. While only the reflection electrode 19 is illustrated as the first electrode in FIG. 3, the first electrode is formed by the reflection electrode 22 and the transparent electrode 23 in the structure illustrated in FIG. 4. In the present invention, any electrode structure may be adopted as long as it has reflectivity.

In the example of FIG. 4, a hole injection layer 24, a hole transport layer 25, a light emitting layer 26, an electron transport layer 27, and an electron injection layer 28 are provided as the organic compound layer 16 in FIG. 3. The present invention is not limited by the materials contained in the layers. For example, the material of the light emitting layer 26 may be any of a fluorescent material and a phosphorescent material, and may contain at least one compound for higher element performance in addition to a host material and a light emitting material. The hole transport layer 25 may function as an electron block layer, and the electron transport layer 27 may function as a hole block layer.

By adjusting the film thickness between the light emitting position of the light emitting layer 26 and a reflective surface of the reflection electrode 22 in the organic compound layer 16, a radiation distribution in the light emitting layer 26 can be controlled. As the display apparatus, by setting the thicknesses of the organic compound layers so that the luminance particularly on the front side becomes high, the luminescent color is controlled by optical interference and light is more efficiently emitted toward the front side. More specifically, by setting the optical distance from the light emitting position of the light emitting layer 26 to an interface between the transparent electrode 23 and the reflection electrode 22 to be n/4 (n=1, 3, 5, . . . ) of the emission wavelength, the luminance in the frontward direction from the light emitting layer 26 toward the light emitting side can be increased further. To enhance the light extraction efficiency, it is preferable that n=1.

For a higher light extraction efficiency, the reflectance of the reflection electrode 22 is preferably as high as possible. For example, as the material of the reflection electrode 22, silver (Ag) is preferable to aluminum (Al). To further increase the reflectance, layers having different refractive indexes may be stacked like a dielectric multilayer film mirror.

In the example of FIG. 4, since the transparent electrode 20 is used as the second electrode, emitted light is not confined in the element. Further, since the high-refractive-index transparent layer 10 is provided on the light emitting side of the transparent electrode 20, emitted light is transmitted to the light extraction structures 7 without being confined and totally reflected. That is, the use of the light extraction structures 7 avoids total reflection occurring between the high-refractive-index transparent layer 10 and air or another medium, and effectively extracts internal light to the outside. While the light extraction efficiency of the organic EL element is said to be normally about 20%, it is greatly enhanced by the above-described structure.

The transparent electrode 20 serving as the second electrode may be replaced with a translucent electrode. In this case, the reflectance of the second electrode increases, and the property of an optical resonator is developed. However, a high-angle radiation light component is produced from the light emitting layer 26, although the amount thereof is small. Hence, the increase in light extraction efficiency is less than in the transparent electrode 20, but the translucent electrode is also effective. The second electrode does not always need to be transparent.

The high-refractive-index transparent layer 10 may be used as a barrier layer against entry of gas such as vapor and oxygen. To function as the barrier layer, although depending on the material to be used, the high-refractive-index transparent layer 10 preferably has a thickness of about several micrometers, more preferably, within the range of 0.5 to 6.0 μm. The preferred thickness does not need to be specified because it depends on the size of the light extraction structures 7. If the thickness of the high-refractive-index transparent layer 10 is more than 6.0 μm, light easily propagates for a long distance through the high-refractive-index transparent layer 10, and is easily extracted from the light extraction structures 7 in the next pixel 4. To enhance the light extraction efficiency, the thickness of the high-refractive-index transparent layer 10 is more preferably within the range of 0.5 to 1.0 μm.

Although the refractive index of the organic compound layers 16, 17, and 18 varies according to the material, it is about 1.6 to 2.0 in a blue light emission region, about 1.5 to 1.9 in a green light emission region, and about 1.5 to 1.8 in a red light emission region. Therefore, it is satisfactory as long as the refractive index of the high-refractive-index transparent layer 10 is at least higher than the refractive index of the organic compound layers 16, 17, and 18 used in the organic EL elements in the blue, green, and red light emission regions. More preferably, the refractive index of the high-refractive-index transparent layer 10 is higher than or equal to 2.0.

For example, the high-refractive-index transparent layer 10 is formed of titanium oxide, zirconium oxide, or zinc oxide. However, it is difficult to process these materials. In the present invention, the high-refractive-index transparent layer 10 is preferably formed by a silicon nitride film (SiNₓ). The elemental composition and elemental composition ratio of the silicon nitride film (SiNₓ) are not particularly limited, and the silicon nitride film may be formed of a mixture of nitrogen and silicon serving as major components and other elements. As a film deposition process for obtaining a silicon nitride film, chemical vapor deposition (CVD) is used. While the optical constant of the silicon nitride film varies according to film deposition conditions such as the substrate temperature and the film deposition speed, in the present invention, it is satisfactory as long as the silicon nitride film is formed by a transparent layer having a refractive index higher than that of the organic compound layers 16, 17, and 18. The light transmittance of the high-refractive-index transparent layer 10 is preferably 85% or more, and more preferably 90% or more.

In the present invention, preferably, the light extraction structures 7 are preferably formed by directly working the high-refractive-index transparent layer 10 so that there is no difference in refractive index between the high-refractive-index transparent layer 10 and the light extraction structures 7.

The light extraction structures 7 are not limited to lens-shaped objects having a lens structure illustrated in FIG. 4, and may have an uneven structure or a diffraction structure. However, the light extraction structures 7 are more preferably formed by lens-shaped objects. Here, the lens-shaped objects refer to objects that are convex in the light extraction direction. These structures reduce return of light into the element resulting from total reflection, and enhance the light extraction efficiency. The shape of bottoms of the lens-shaped objects is a circular shape, an elliptic shape, or a polygonal shape with three or more corners, and the cross-sectional shape of the lenses in the height direction is any of a hemispherical shape, a trapezoidal shape, or a conical shape, or a combination thereof. Further, a plurality of light extraction structures 7 are preferably provided on the sub-pixels 1, 2, and 3.

These light extraction structures 7 are preferably arranged in the pixels 4 to extract as much light emitted 360° in the plane as possible. For example, when the bottom shape is circular, the light extraction structures 7 are preferably arranged in a close-packed hexagonal manner, as illustrated in FIG. 2. When the bottom shape is rectangular, the light extraction structures 7 may be arranged in a staggered manner, as illustrated in FIG. 5.

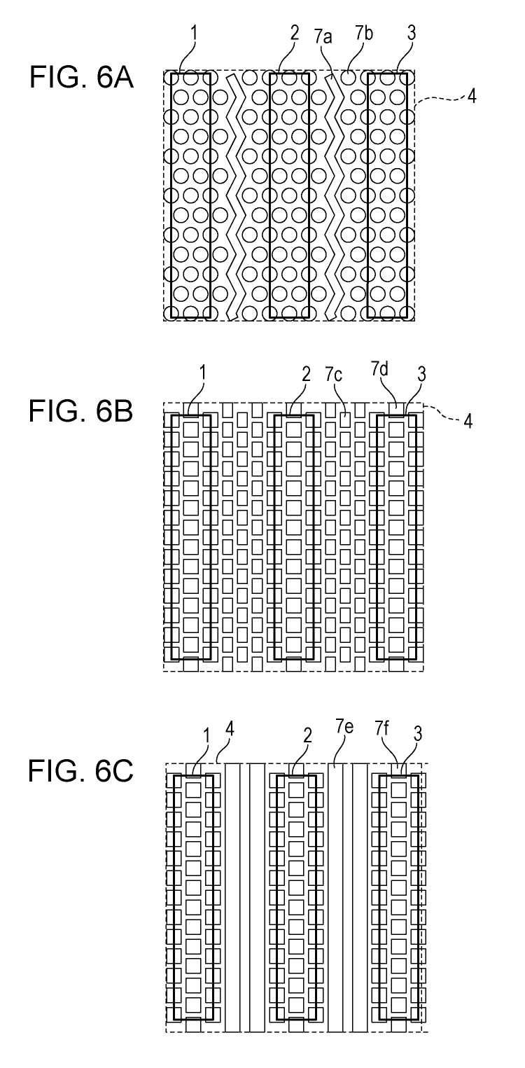

The arrangement pattern of the light extraction structures 7 may be uniform over the entire plane. Further, the shape of the light extraction structures 7 may be different between the sub-pixels 1, 2, and 3 and the inter-sub-pixel regions, as in light extraction structures 7a and 7b illustrated in FIG. 6A, light extraction structures 7c and 7d illustrated in FIG. 6B, and light extraction structures 7e and 7f illustrated in FIG. 6C. For example, when the sub-pixels have a short side length of 10 μm and a long side length of 60 μm, hemispherical lenses of several micrometers and cylindrical lenses having a width of several micrometers may be combined, or cones, quadrangular pyramids, or polygonal pyramids of several micrometers and structures having a width of several micrometers and having a cross section shaped like a right triangle, an isosceles triangle, or a trapezoid may be combined.

While a production method for the light extraction structures 7 is not particularly limited, for example, after a resist pattern is formed on a film of SiNₓ or the like by photolithography, desired structures may be formed by dry etching. Alternatively, after a desired mold pattern is transferred on a SiNₓ film by nanoimprinting, the SiNₓ film may be subjected to dry etching.

When the size of the sub-pixels 1, 2, and 3 is several tens of micrometers square, the light extraction structures 7 preferably have a size or width of the order of microns. This is because, when a high-angle component of light emitted into the high-refractive-index transparent layer 10 enters the light extraction structure 7, it is not always extracted at one time, but may be extracted from the second or third light extraction structure 7. Further, the light may be extracted after impinging the second or third light extraction structure 7 and changing its angle because of reflection caused at the interface between the light extraction structure 7, and air or a low-refractive-index layer. Therefore, to achieve a higher light extraction efficiency, it is preferable to form a sufficient number and size of light extraction structures 7 in correspondence to the area of the sub-pixels 1, 2, and 3. More preferably, the light extraction structures 7 are formed not only on the sub-pixels 1, 2, and 3, but also in the regions between two adjacent sub-pixels in the pixels 4 (inter-sub-pixel regions 5 in FIG. 1).

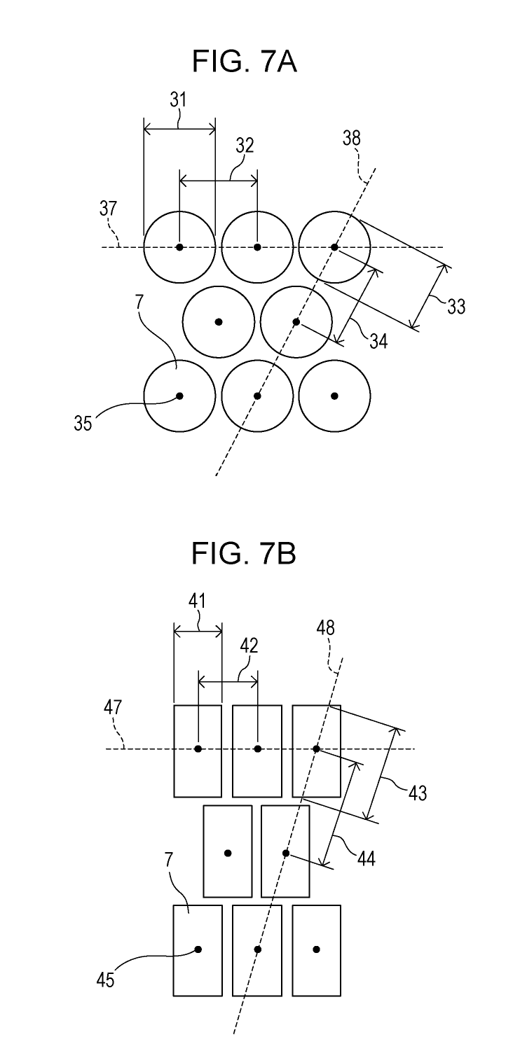

In order for the light extraction structures 7 to sufficiently contribute to enhancement of the light extraction efficiency, the light extraction structures 7 are preferably arranged tightly. More preferably, as illustrated in the FIGS. 7A and 7B, the following condition is satisfied:

1.0≦B/A≦1.2 (1)

where A represents the diameter of the bottoms of the light extraction structures 7 (FIG. 7A) or the length of the bottom faces along the axis passing through the centers of the light extraction structures 7 (FIG. 7B), and B represents the center-to-center distances between the light extraction structures 7. In FIGS. 7A and 7B, reference numerals 37 and 47 denote horizontal arrangement axes of the light extraction structures 7, reference numerals 38 and 48 denote oblique arrangement axes, and reference numerals 35 and 45 denote the centers of the light extraction structures 7. Reference numeral 31 denotes the diameter (A) of the bottoms of the light extraction structures 7 along the arrangement axis 37, and reference numeral 32 denotes the center-to-center distance (B) between the light extraction structures 7 along the arrangement axis 37. Reference numeral 33 denotes the diameter (A) of the bottoms of the light extraction structures 7 along the arrangement axis 38, and reference numeral 34 denotes the center-to-center distance (B) between the light extraction structures 7 along the arrangement axis 38. Further, reference numeral 41 denotes the length (A) of the bottom faces of the light extraction structures 7 along the arrangement axis 47, and reference numeral 42 denotes the center-to-center distance (B) between the light extraction structures 7 along the arrangement axis 47. Reference numeral 43 denotes the length (A) of the bottom faces of the light extraction structures 7 along the arrangement axis 48, and reference numeral 44 denotes the center-to-center distance (B) between the light extraction structures 7 along the arrangement axis 48.

When the light extraction structures 7 are more tightly arranged, the opportunity for light reaching the high-refractive-index transparent layer 10 to exit outside through the light extraction structures 7 increases. For example, since light from a specific point is emitted 360°, when there is a gap between two adjacent light extraction structures 7, light emitted at an angle corresponding to the gap is not extracted, and is extracted after entering the next light extraction structure 7.

When the light extraction structures 7 are provided on the inter-sub-pixel regions 5, light emitted from the sub-pixels adjacent to the inter-sub-pixel regions 5 enters the inter-sub-pixel regions 5 and are then extracted therefrom. However, color mixture caused by the light extraction structures 7 in the pixels 4, for example, color mixture of blue, green and red is additive color mixture of gradation-controlled colors. Hence, this does not have any influence on the control for obtaining a desired chromaticity. If anything, the light extraction efficiency is enhanced because light propagating to the adjacent sub-pixels can be extracted.

In contrast, in the light extraction structures 7 provided on the interpixel regions 6, luminescent colors of light emitted from the sub-pixels differently gradation-controlled are mixed. For example, a mixed color between a red sub-pixel 3 and a blue sub-pixel 1, which are included in different pixels 4 and are adjacent to each other with the interpixel region 6 being disposed therebetween, does not correspond to luminescent colors to be extracted by gradation control of the sub-pixels, but the mixed color is extracted as an unintended color of additive mixture.

Here, a MacAdam ellipse will be considered as an example. Green is less sensitive to a chromaticity shift than red and blue, and blue is highly sensitive to a chromaticity shift. Accordingly, bleeding of a display image will be described by taking, as an example, a blue sub-pixel 1 that emits light having a blue luminescent color in the structure of FIG. 1. When light with a different color enters the blue sub-pixel 1 from a sub-pixel gradation-controlled differently, a color difference of blue is caused. In this case, while light emitted from the blue sub-pixel 1 has a desired chromaticity, the chromaticity of the luminescent color of light extracted from the adjacent interpixel region 6 is shifted by mixture of a color of the adjacent red sub-pixel 3. For this reason, a color close to a desired blue is recognized on the blue sub-pixel 1, but a color different from the desired blue is recognized on the interpixel region 6. Thus, the luminescent color of light from the blue sub-pixel 1 is recognized as a color in which red is mixed, and color bleeding occurs. Further, since chromaticity is shifted with respect to a predetermined gradation control for each pixel for image display in the interpixel region 6, an edge portion of a displayed image bleeds. When the blue sub-pixel 1, the red sub-pixel 3, and the green sub-pixel 2 are arranged in this order in the pixel 4, color mixture between the blue sub-pixel 1 and the green sub-pixel 2 adjacent to each other with the interpixel region 6 being disposed therebetween occurs in the interpixel region 6.

In a normal display apparatus, the apertures of the pixels are typically arranged at a regular pitch. Since the aperture ratio is no less than about 50%, the interpixel regions 6 occupy a wide area. Therefore, color mixture occurring in the blue region forms a region having a different chromaticity, and this causes bleeding of a display image. To prevent such bleeding, the light extraction structures are not provided on the interpixel regions 6, as illustrated in FIG. 2. More preferably, the regions where the light extraction structures are not provided separate the pixels 4 including the light extraction structures 7. More specifically, as illustrated in FIG. 2, regions where the light extraction structures are not provided (interpixel regions 6) are connected in a grid pattern.

The width of the interpixel regions 6, that is, the distance between the adjacent pixels 4 needs to be determined in consideration of a light propagation distance. The light propagation distance refers to the distance between a light emitting point and a point where the light intensity at the light emitting point is reduced by half. The light propagation distance relates to the thickness and absorptance of the high-refractive-index transparent layer 10 and the luminescent color. In the present invention, the bleeding prevention effect of the regions, where the light extraction structures are not provided, is not specified by the luminescent color for the above-described reason. However, the width of the interpixel regions 6 is at least more than the diameter of the bottom faces of the light extraction structures 7 or the length of the longest diagonal line in the polygonal bottom faces. Further, the width of the interpixel regions 6 is preferably more than or equal to the light propagation distance.

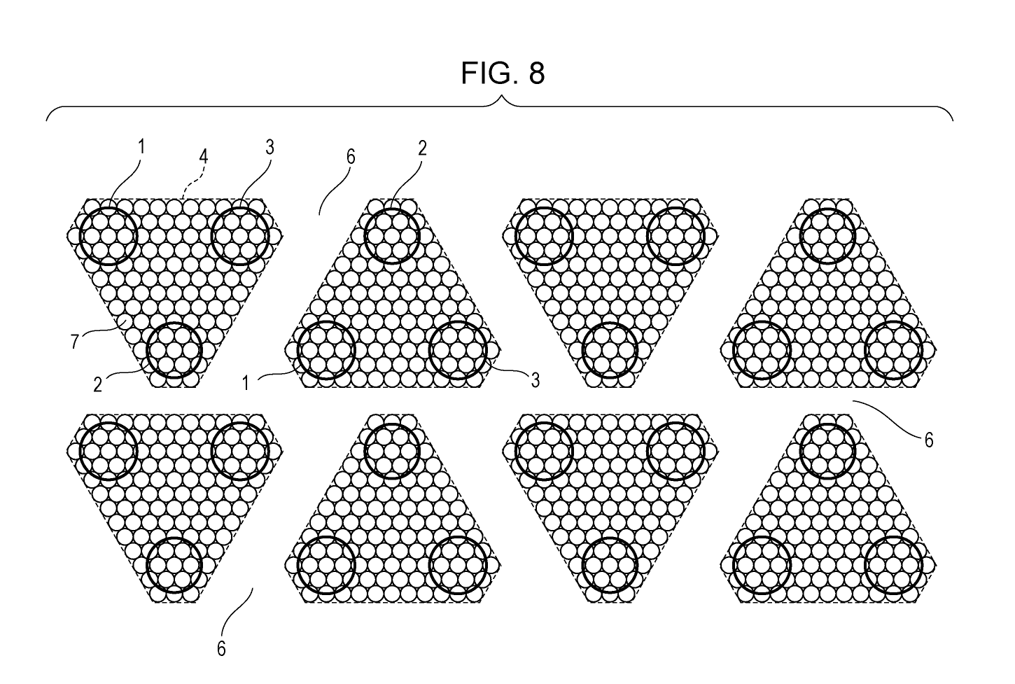

In the present invention, the width of the interpixel regions 6 corresponds to the length of the interpixel regions 6 in the X-direction and Y-direction when the pixels and the sub-pixels are arranged linearly in the X-direction and Y-direction, as illustrated in FIG. 2. In a layout illustrated in FIG. 8, the width of the interpixel regions 6 corresponds to the length of the narrowest portions in the interpixel regions 6.

The shape of the apertures of the sub-pixels 1, 2, and 3 is not limited to a rectangular shape, and may be a circular shape illustrated in FIG. 8. For example, since light is radiated three-dimensionally and isotropically, the light extraction structures 7 can be effectively arranged in circular apertures. To effectively prevent bleeding of a display image due to unintended or undesirable additive color mixture, even when the sub-pixels are circular, the light extraction structures 7 are provided on the sub-pixels 1, 2, and 3 and the inter-sub-pixel regions in the pixels, but are not provided on the interpixel regions.

Circuits and lines for driving the display apparatus of the present invention and the arrangement and properties of TFTs to be used are not particularly specified, and may be appropriately designed to obtain the required performance.

In the display apparatus of the present invention, the light extraction structures serve to extract, to the outside, light confined in the elements, and the light extraction structures may be further hermetically covered with sealing glasses such as glass caps or glass plates. On the sealing glasses, color filters for improving chromaticity or circularly polarizing plates for reducing reflection of outside light may be provided.

### EXAMPLES

Specific examples of the present invention will be described below.

### Example 1

A display apparatus was produced as Example 1, in which organic EL elements had a cross-sectional structure of FIG. 4, a display region had a cross-sectional structure of FIG. 3, and pixels, sub-pixels and light extraction structures were arranged in a layout of FIG. 2. That is, the display apparatus of Example 1 includes a plurality of pixels, each pixel includes sub-pixels of a plurality of colors (blue sub-pixel 1, green sub-pixel 2, red sub-pixel 3), and each sub-pixel includes an organic EL element. The display apparatus of Example 1 was produced in the following method.

In Example 1, first, a TFT driving circuit (not illustrated) formed of low-temperature polysilicon was formed on a glass substrate, and a planarizing film (not illustrated) formed of acrylic resin was formed thereon to obtain a support substrate 9. Next, an Ag alloy film having a thickness of about 150 nm was formed as a reflection electrode 22 on the support substrate 9 by sputtering. The reflection electrode 22 formed of an Ag alloy is a high reflection film having a spectral reflectivity of 80% or more in a visible light wavelength range (λ=380 to 780 nm). Further, an indium tin oxide (ITO) film was formed as a transparent electrode 23 by sputtering. After that, polyimide resin was spin-coated as partitions 15, and apertures were formed in desired sub-pixels by photolithography.

Subsequently, organic compound layers were sequentially formed and stacked by vacuum deposition. In each of the sub-pixels 1, 2, and 3 in the display apparatus of Example 1, the thickness of a hole transport layer 25 was changed so that the optical film thickness from a light emitting layer 26 to the reflection electrode 22 corresponded to ¾ of the wavelength of light with the luminescent color. As a luminescent dopant in the light emitting layer 26, a fluorescent material was used for blue, and a phosphorescent material was used for green and red. The phosphorescent material can be effective in enhancing internal quantum efficiency. The refractive index of the layer having the highest refractive index in the organic compound layers of the sub-pixels was 1.86 in the blue sub-pixels, 1.80 in the green sub-pixels, and 1.78 in the red sub-pixels.

Next, an indium zinc oxide (IZO) film was formed as a transparent electrode 20 by sputtering. After that, a silicon nitride (SiN) film having a thickness of 4 μm was formed by CVD. The refractive index of the SiN film was 1.89 at 450 nm (blue region), 1.88 at 520 nm (green region), and 1.86 at 620 nm (red region). Hence, in all the sub-pixels, the refractive index of the SiN film was higher than that of the organic compound layers. The surface of the SiN film was reformed by spin-coating hexamethyldisilazane, and AZ1500 was spin-coated as a photoresist, thereby obtaining a film having a thickness of about 2.5 μm. The film was exposed by a mask aligner MPA600FA with a photomask that does not have a pattern on interpixel regions 6 and has dots of 5 μm in diameter on pixels, as illustrated in FIG. 2. Next, development was performed with an AZ312MIF developer to obtain a resist pattern. The resist pattern was subjected to post baking at 120° C. for three minutes to reflow a resist shape. By being etched together with the resist pattern by dry etching using carbon tetrafluoride and oxygen, the SiN film was processed into microlenses having a diameter of 5 μm. In this case, a thickness of the high refractive-index transparent layer 10 having a refractive index higher than that of the organic compound layers 16, 17, and 18 was 1.5 μm, and the height of the microlenses was 2.5 μm. The lens pitch was 7 μm.

The width of the interpixel regions 6 (regions where light extraction structures were not provided) was 11.0 μm in the X-direction and 12.3 μm in the Y-direction. Therefore, in the interpixel regions 6, there was no portion narrower than the diameter of the bottoms of the microlenses. The ratio (B/A) between the diameter (A) of the bottoms of the microlenses and the pitch (B) of the microlenses was 1.4.

To check the degree of bleeding in the display apparatus produced in the above-described manner, a human image was displayed against a background of the blue sky, and luminescent color at an outline of a white portion, such as skin, was checked. At the outline of the displayed human image obtained by Example 1, a change in luminescent color due to bleeding was not found.

In Example 1, the light extraction efficiency was about 40%. The light emission intensity was increased at all the viewing angles.

### Comparative Example 1

A display apparatus was produced as Comparative Example 1 by a production process similar to that adopted in Example 1. The display apparatus of Comparative Example 1 was similar in structure to the display apparatus of Example 1 except that light extraction structures are also provided on interpixel regions 6. The degree of bleeding in the obtained display apparatus was checked in a manner similar to that adopted in Example 1. A change in luminescent color resulting from bleeding was found at an outline of a displayed human image, and bleeding of a blue-violet color was found at the outline. The light extraction efficiency was about 41% similarly to Example 1, and the luminance was increased at all the viewing angles.

### Example 2

A display apparatus was produced as Example 2 by a production method similar to that adopted in Example 1. The display apparatus of Example 2 was similar in structure to the display apparatus of Example 1 except that the lens pitch was reduced to 6 μm. The width of interpixel regions 6 (regions where light extraction structures were not provided) was 13.0 μm in the X-direction and 12.3 μm in the Y-direction. In the interpixel regions 6 (regions where light extraction structures were not provided), there was no portion narrower than the diameter of bottoms of microlenses. The ratio (B/A) between the diameter (A) of the bottoms of the microlenses and the pitch (B) of the microlenses was 1.2.

The degree of bleeding in the obtained organic EL display apparatus was checked in a manner similar to that adopted in Example 1. A change in luminescent color resulting from bleeding was not found at an outline of a displayed human image. The light extraction efficiency was about 44%, and the luminance was increased at all the viewing angles.

### Example 3

A display apparatus was produced as Example 3 by a production method similar to that adopted in Example 1 except that photography was performed by gradation exposure using a gray-tone mask as a photomask. The display apparatus of Example 3 was similar in structure to the display apparatus of Example 1 except that the lens pitch was 5 μm and microlenses having a diameter of 5 μm were tightly arranged. The length of interpixel regions 6 (regions where light extraction structures were not provided) was 15.0 μm in the X-direction and 15.7 μm in the Y-direction. In the interpixel regions 6 (regions where light extraction structures were not provided), there was no portion narrower than the diameter of bottoms of the microlenses. The ratio (B/A) between the diameter (A) of the bottoms of the microlenses and the pitch (B) of the microlenses was 1.0.

The degree of bleeding in the obtained display apparatus was checked in a manner similar to that adopted in Example 1. A change in luminescent color resulting from bleeding was not found at an outline of a displayed human image. The light extraction efficiency was about 47%, and the luminance was increased at all the viewing angles.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-085397 filed Apr. 7, 2011, which is hereby incorporated by reference herein in its entirety.

What is claimed is:

1. A display apparatus comprising a plurality of pixels each including a plurality of sub-pixels configured to emit light with different colors,
wherein each of the sub-pixels has an organic EL element including a first electrode, a second electrode, and an organic compound layer including a light emitting layer provided between the first electrode and the second electrode,
wherein a transparent layer having a refractive index higher than a refractive index of the organic compound layer is provided on a light emitting side of the organic EL element,
wherein a light extraction structure is provided on a light emitting side of the transparent layer, and
wherein the light extraction structure is provided on the sub-pixels in the pixels and is not provided on a region between two adjacent pixels.

2. The display apparatus according to claim 1, wherein the light extraction structure is provided on a region between two adjacent sub-pixels in the pixels.

3. The display apparatus according to claim 1, wherein the light extraction structure provided on the sub-pixels in the pixels and a light extraction structure provided on a region between two adjacent sub-pixels have different shapes.

4. The display apparatus according to claim 1, wherein the region where the light extraction structure is not provided continuously extends in a grid pattern.

5. The display apparatus according to claim 1, wherein the light extraction structure has a lens shape.

6. A display apparatus comprising a plurality of pixels each including a plurality of sub-pixels configured to emit light with different colors,
wherein each of the sub-pixels has an organic EL element including a first electrode, a second electrode, and an organic compound layer including a light emitting layer provided between the first electrode and the second electrode,
wherein a transparent layer having a refractive index of 2.0 or more is provided on a light emitting side of the organic EL element,
wherein a light extraction structure is provided on a light emitting side of the transparent layer, and
wherein the light extraction structure is provided on the sub-pixels in the pixels, and is not provided in a region between two adjacent pixels.

7. The display apparatus according to claim 6, wherein the light extraction structure is provided on a region between two adjacent sub-pixels in the pixels.

8. The display apparatus according to claim 6, wherein the light extraction structure provided on the sub-pixels in the pixels and a light extraction structure provided on a region between two adjacent sub-pixels have different shapes.

9. The display apparatus according to claim 6, wherein the region where the light extraction structure is not provided continuously extends in a grid pattern.

10. The display apparatus according to claim 6, wherein the light extraction structure has a lens shape.
